(19) United States
(12) Patent Application Publication
(10) Pub. No.: US 2025/0025274 A1
(43) Pub. Date: Jan. 23, 2025

(54) REMOVABLE TMJ THERAPEUTIC ORTHOTIC

(71) Applicant: Hitesh K. Patel, Naperville, IN (US)

(72) Inventor: Hitesh K. Patel, Naperville, IN (US)

(21) Appl. No.: 18/222,593

(22) Filed: Jul. 17, 2023

(51) Int. Cl. A61C 19/06; A61C 7/36

(52) U.S. Cl. CPC A61C 19/06; A61C 7/36

(57) ABSTRACT

A one-piece removable therapeutic dental orthotic to be worn on a wearer's lower dentition. The orthotic has occlusally bulging fulcrum regions positioned over a wearer's left and right first molar and second bicuspid, so that the orthotic initially contacts only a pair of fulcrum teeth of the wearer's upper dentition during the wearer's jaw closure movement, without any of the wearer's teeth touching each other. The initial contact locations serve as a fulcrum, and clearance is provided between the wearer's upper dentition and clearance regions of the orthotic on mesial and distal sides of the fulcrum regions, allowing the wearer's jaw to pivot about the fulcrum while the upper dentition remains in contact with the fulcrum regions and touches no other part of the orthotic.

### CROSS REFERENCE

None.

### FIELD OF THE DISCLOSURE

The present disclosure relates to removable therapeutic intra-oral orthotics that can be worn to treat, relieve symptoms of, and/or improve functions affected by disorders of the muscles and joints associated with head, face, and jaw movements, such as temporomandibular joint (TMJ) disorders (TMDs). More particularly, it relates to such orthotics that are worn over a wearer's teeth and/or are operative to engage a wearer's teeth when worn.

### SUMMARY

According to an aspect of the disclosure, a removable therapeutic dental orthotic comprises a one-piece body adapted and configured to be worn over a user's lower dentition. The body comprises lefthand and righthand occlusally protruding fulcrum regions, each fulcrum region being so positioned relative to the user's lower dentition as to initially contact the user's upper dentition only on the user's corresponding left or right first molar of the upper dentition, when the user's upper dentition includes such left or right first molar, when the orthotic is so worn during the user's jaw closure movement. The orthotic is adapted and configured to permit the user's lower dentition to pivot sagittally relative to the user's upper dentition, while the fulcrum regions remain in contact with the upper dentition, about the respective locations of such contact.

### BRIEF DESCRIPTION OF THE DRAWINGS

Although the characteristic features of this disclosure will be particularly pointed out in the claims, the subject matter of the claims, and the manner in which it may be made and used, may be better understood by referring to the following description taken in connection with the accompanying drawings forming a part hereof, wherein like reference numerals refer to like parts throughout the several views and in which:

FIG. 1 is a left-side perspective view of a dental orthotic according to an embodiment of the disclosure.

FIG. 2 is a top-anterior-right perspective view of the dental orthotic of FIG. 1.

FIG. 3 is an anterior perspective view of the dental orthotic of FIG. 1.

FIG. 4 is a top plan view of the dental orthotic of FIG. 1.

FIG. 5 is a left-side elevation view of a dental orthotic according to another embodiment.

FIG. 6 is a top plan view of the dental orthotic of FIG. 5.

FIG. 7 is a right-side elevation view of the dental orthotic of FIG. 5 as used in a method according to another embodiment, worn on the lower dentition of a user whose jaw is at physiologic rest.

FIG. 8 is a right-side elevation view of the dental orthotic worn as shown in FIG. 7, with the user's jaw partially closed to an initial position of contact by the orthotic on the user's upper dentition.

A person of ordinary skill in the art will appreciate that elements of the figures above are illustrated for simplicity and clarity and are not necessarily drawn to scale. The dimensions of some elements in the figures may have been exaggerated relative to other elements to help understanding of the present teachings. Furthermore, a particular order in which certain elements, parts, components, modules, steps, actions, events and/or processes are described or illustrated may not be actually required. A person of ordinary skill in the art will appreciate that, for the purpose of simplicity and clarity of illustration, some commonly known and well-understood elements that are useful and/or necessary in a commercially feasible embodiment may not be depicted in order to provide a clear view of various embodiments in accordance with the present teachings.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting unless the claims expressly state otherwise.

Removable therapeutic dental orthotics according to the present disclosure are now described in detail, with reference to the accompanying drawings. Without limitation, the orthotics can be worn to treat or relieve the symptoms of one or more disorders of the temporomandibular joint (TMJ), commonly referred to as temporomandibular (joint) disorders or TMDs. The disclosed orthotics are adapted and configured to provide various benefits to a wearer thereof. Such benefits can include reduction or elimination of earaches, headaches/migraines, facial pain, neck pain, dizziness and/or movement disorders; as well as improvement in balance and/or neck rotation, thereby improving the wearer's quality of life.

In a method of use according to an embodiment of the disclosure, a user wears the disclosed orthotic at all times of day for a temporary period, during both waking and sleeping hours, except when eating, resulting in benefits that last beyond the temporary period of use. The temporary period of use can be of a predetermined duration, such as a number of days, weeks, or months as prescribed by a dentist, or the user can wear the device until such time as a desired result is attained. Following this period, the user may, for example, continue to wear the disclosed orthotic only to sleep, begin wearing a substitute permanent orthotic to sleep, or stop wearing any orthotic, while continuing to experience benefits attained through temporary use of the orthotic.

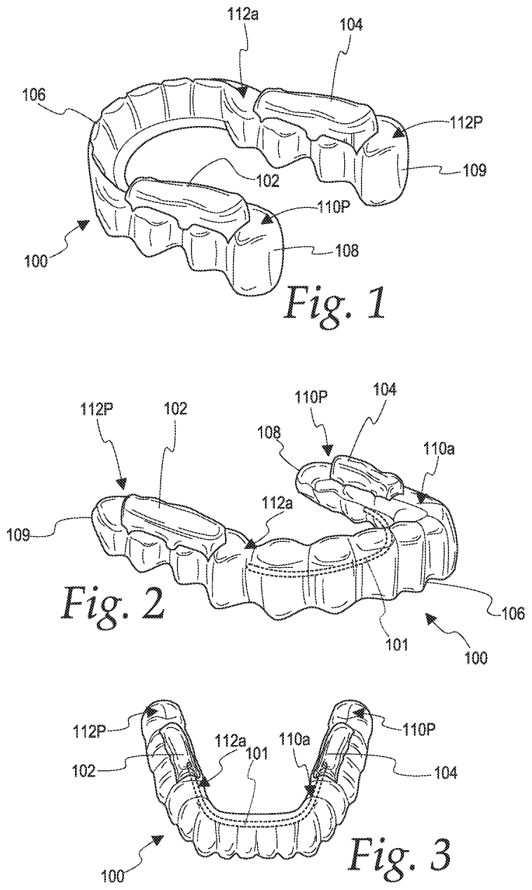

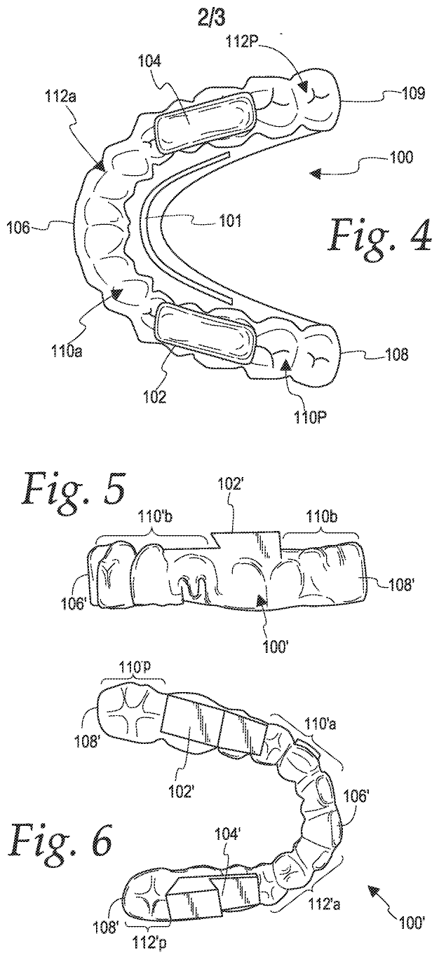

A removable therapeutic dental orthotic 100 according to an embodiment of this disclosure is illustrated in FIGS. 1-4 and 7 of the accompanying drawings. The orthotic 100 is typically of a one-piece custom-molded construction, comprising molded acrylic, other suitable moldable material(s), and/or over-molded structure (such as the wire 101 seen in FIGS. 2-4 and 7) for intra-oral use. The orthotic 100 comprises a one-piece body that is illustrated as being adapted and configured to fit over a user's lower (mandibular) dentition. Typically, the orthotic 100 is custom molded for a particular user from an impression of the user's lower teeth taken by a dental professional according to any suitable known method, such as one commonly practiced in the art of custom molding removable intra-oral orthotics worn over a wearer's teeth, including for example orthodontic retainers and night guards. The body of the orthotic 100 comprises a left fulcrum region 102 and a right fulcrum region 104, each fulcrum region 102, 104 protruding or bulging occlusally (that is, upwardly toward the opposite, maxillary dentition) on an occlusal (upper) side of the orthotic.

The body of the orthotic 100 has vertical cross sections extending from a lingual (inner) side to a buccal (outer) side of each of the wearer's lower molars and premolars, wrapping over their respective occlusal (upper) sides. A horizontal cross section of the orthotic includes a lingual peripheral edge that extends continuously along the lingual sides of each of the wearer's lower teeth from a right posterior end 109 at a rear side of the wearer's rearmost molar (typically the second molar M2 or the wearer's wisdom tooth if present) in a mesial direction to an anterior end region 106 at the wearer's front incisors, and from the anterior end region 106 in a distal direction to a left posterior end 108 opposite the right posterior end 109. The body of the orthotic 100 when worn does not cover the labial (front) sides of the wearer's incisors, but only their lingual (rear) sides and incisal edges (tips). The anterior region 106 of the body of the orthotic 100 extends over the lingual sides of the wearer's mandibular (lower) incisors to connect a left side molar and premolar region to a right side molar and premolar region of the body. In other embodiments, the body of a removable therapeutic dental orthotic can extend over other suitable regions of the facial sides, lingual sides, and occlusal sides/incisal edges of a user's teeth so as to be securely worn thereon in such as a way as to prevent movement relative to the lower dentition other than removal in an upward direction (or in the case of an analogous orthotic worn on the upper/maxillary dentition, removal in a downward direction, or stated universally, removal in a direction toward the opposite dentition).

For ease of illustration and description of the orthotic 100, an illustrative dental orthotic 100′ is illustrated in FIGS. 5-8, certain features being shown in exaggerated and/or simplified form, as well as portions of its outer surface being formed for ease of positional reference into the shapes of the corresponding teeth over which the illustrative orthotic 100′ is worn. The orthotic 100′ comprises a one-piece body that is adapted and configured to be worn on a user's mandibular (lower) dentition, the body of the orthotic 100′ having upward protrusions within left and right fulcrum regions 102′, 104′, and when so worn, the body extending having a lingual side extending continuously along a peripheral arc from a right posterior end 109′ at a user's rearmost lower right molar in a mesial/forward direction to an anterior end region 106′ at a user's front lower incisors, and from the anterior end region 106′ in a distal direction to a left posterior end 108′ at a user's rearmost lower left molar, which is illustrated as the user's second molar M2, the third molar/“wisdom tooth” being assumed to be absent. The left and right fulcrum regions 102′, 104′ are illustrated as having flat faces rather than irregular contours for ease of identification.

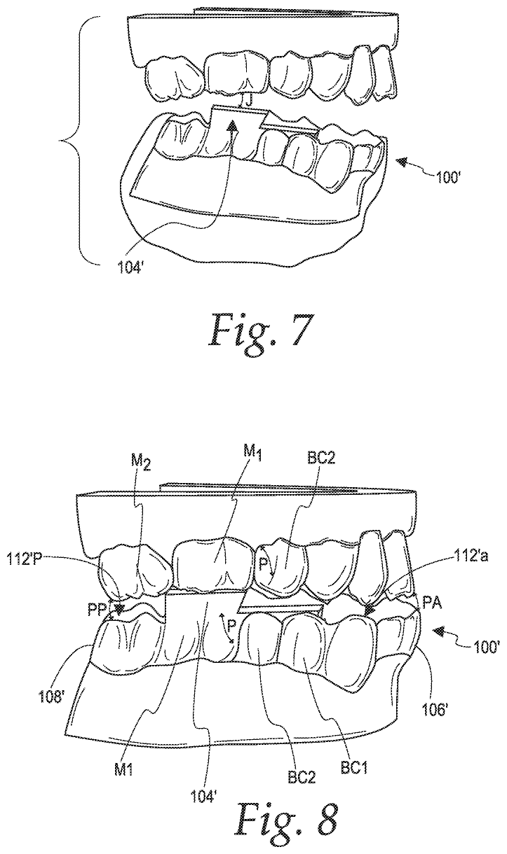

Turning to FIG. 7, the fulcrum regions 102′, 104′ are located so that, when the orthotic 100′ is worn on a user's lower dentition and the user's jaw is at a partially open physiologic rest position, the orthotic 100′ does not contact the user's upper dentition. A physiologic rest clearance J is thus present between the orthotic 100′ and the upper dentition along the user's arc of jaw closure represented by the double arrow at J.

When the user's jaw tries to close from the physiologic rest position to a fully closed, teeth-together position (not shown), normal jaw movement along the arc of jaw closure J is interrupted by initial contact of the fulcrum regions 102′, 104′ of the orthotic 100′ on the user's upper dentition in the position illustrated in FIG. 8. In this initial contact position, the upper dentition contacts the fulcrum regions 102′, 104′ and not any other part of the orthotic 100′ or any lower tooth. More particularly, such initial contact is by just one fulcrum tooth on each left and right side of the user's upper dentition on a point or points within the corresponding fulcrum region 102′, 104′. Preferably, the fulcrum teeth are the user's left and right upper first molars M1 (denoted UL6 or UR6 in one conventional alphanumeric dental notation system). In other embodiments (not shown) of an orthotic made for a user whose upper first molar M1 is missing on either side, the orthotic can be made with fulcrum regions to engage as alternate fulcrum teeth a left/right pair of the user's upper teeth that are both present, such as the user's left and right upper second bicuspids BC2, first bicuspids BC1, or second molars M2. When the orthotic 100′ is worn, the fulcrum regions 102′, 104′ are generally positioned over the lower counterparts of the fulcrum teeth. Thus, in the illustrated embodiment, the fulcrum regions 102′, 104′ are generally positioned over the left and right lower first molar (LL6 and LR6) respectively. More particularly, the fulcrum regions 102′, 104′ are positioned entirely mesial (forward) to the wearer's corresponding left and right lower second molar (LL7 or LR7). Still more particularly, each fulcrum region 102′, 104′ spans the entire mesiodistal dimension of the corresponding left or right lower first molar. As illustrated, the fulcrum regions 102′, 104′ can also overlap or overhang a small portion of a mesiodistal width of the corresponding left or right lower second bicuspid (LL5 or LR5), such as less than one fourth. In the case of embodiments made for a user who is missing one or both upper first molars, the fulcrum regions can be analogously positioned with respect to the lower counterparts of the alternate fulcrum teeth.

Contact by the fulcrum teeth on the fulcrum regions 102′, 104′ creates a fulcrum, and further contraction of the user's muscles of jaw closure following said initial contact can result in sagittal pivoting of the user's lower dentition about the fulcrum. The points or areas of such contact on each fulcrum region 102′, 104′ can, but need not, move during such pivoting, such as by the fulcrum tooth rolling or sliding over the corresponding fulcrum region 102′, 104′. Thus, an axis of such pivoting can remain in a fixed position or, for example, shift mesiodistally (forward or backward on the fulcrum tooth and/or on the fulcrum regions 102′, 104′) while remaining generally horizontal and mediolateral. From the initial contact position shown in FIG. 8, the lower jaw can pivot sagittally counterclockwise, into an anterior pivotal clearance gap PA between the upper dentition and an anterior clearance region 112a of the orthotic 100′, and/or clockwise, into a posterior pivotal clearance gap PP between the upper dentition and a posterior clearance region 112p of the orthotic 100′. Preferably, the orthotic 100′ is formed for a user so that the user's jaw either cannot, or will reflexively avoid (such as by proprioceptive action of the trigeminal nerve), pivoting far enough in either counterclockwise or clockwise direction from the initial contact position to close the respective clearance gap PA, PP, such that the orthotic 100′ contacts only the pair of fulcrum teeth and no other tooth of the upper dentition when worn by the user. Thus, in embodiments, a height of the occlusal side of the orthotic 100′ drops off sharply in both the distal (rearward) and mesial (forward) directions from the fulcrum regions 102′, 104′.

Such sagittal pivoting of the user's jaw about the fulcrum formed by contact of the fulcrum teeth on the orthotic 100′ within the fulcrum regions 102′, 104′, within the anterior and posterior pivotal clearances PA, PP, is believed to provide various benefits that can improve the user's quality of life, such as eliminating or reducing jaw pain; eliminating or reducing ear pain; eliminating or reducing headaches/migraine; eliminating or reducing facial pain; eliminating or reducing neck pain; eliminating or reducing balance problems; eliminating or reducing dizziness; helping with neck rotation; and reducing and/or addressing movement disorders, such as remediating damage from parafunctional jaw clenching or tooth grinding, (a/k/a bruxism).

Advantages of the invention will be further understood and appreciated by those skilled in the art by reference to the foregoing description, the following claim(s), and the accompanying drawing(s). It is intended that all matters described and disclosed therein be interpreted as illustrative and not in a limiting sense.

While the invention has been described with respect to certain embodiments, as will be appreciated by those skilled in the art, it is to be understood that the scope of the invention can include numerous changes, modifications and rearrangements to those embodiments, and such changes, modifications and rearrangements are intended to be covered by the following claims. In addition, although narrow claims may be presented below, it should be recognized that the scope of the invention is much broader than presented by the claim(s). It is intended that broader claims will be submitted in one or more applications that claim the benefit of priority from this application. To the extent that the description above and the accompanying drawings disclose one or more inventions not within the scope of the claim or claims below, such inventions are not dedicated to the public and the right to file one or more applications to claim such additional inventions is reserved.

What is claimed is:

1. A removable therapeutic dental orthotic comprising:
a one-piece body adapted and configured to be worn over a user's lower dentition;
the body comprising lefthand and righthand occlusally protruding fulcrum regions, each fulcrum region being so positioned relative to the user's first dentition as to initially contact the user's upper dentition only on the user's corresponding left or right first molar of the upper dentition, when the user's upper dentition includes such left or right first molar, when the orthotic is so worn during the user's jaw closure movement;
the orthotic being adapted and configured to permit the user's first dentition to pivot sagittally relative to the user's upper dentition, while the fulcrum regions remain in contact with the upper dentition, about the respective locations of such contact.

2. The removable therapeutic dental orthotic of claim 1 wherein the body further comprises lefthand and righthand pivotal clearance regions disposed mesially and distally of the corresponding fulcrum regions, the pivotal clearance regions being separated from the user's upper dentition by a pivotal clearance when the user's first dentition is at the position of said initial contact by the orthotic on the user's upper dentition.

3. A method of using a removable therapeutic dental orthotic comprising a one-piece body and lefthand and righthand occlusally protruding fulcrum regions, the method comprising:
a user wearing the orthotic body over a lower dentition of the user;
the user's jaw moving along an arc of closure from an open position to an initial contact position, the upper dentition in the open position being out of contact with the orthotic and the first dentition, the upper dentition in the initial contact position contacting the fulcrum regions and contacting no other part of the orthotic body or the first dentition;
the user's jaw moving so as to pivot the first dentition sagittally relative to the upper dentition from the initial contact position to a sagittally pivoted position while the fulcrum regions remain in contact with the upper dentition.
